(19) United States
(12) Patent Application Publication
(10) Pub. No.: US 2014/0103153 A1
(43) Pub. Date: Apr. 17, 2014

(54) Grain Mill

(71) Applicant: Scott Charles Below, Kalamazoo, MI (US)

(72) Inventor: Scott Charles Below, Kalamazoo, MI (US)

(21) Appl. No.: 14/053,892

(22) Filed: Oct. 15, 2013

Related U.S. Application Data
(60) Provisional application No. 61/714,808, filed on Oct. 17, 2012.

(51) Int. Cl. B02C 21/02; B02C 4/30; B02C 4/16

(52) U.S. Cl. CPC B02C 21/02; B02C 4/16; B02C 4/30
USPC 241/100; 241/221; 241/242; 241/224

(57) ABSTRACT

An improved grain mill is presented herein comprising a dispenser adapted to receive and store a material, and a grinding mill adapted to receive the material from the dispenser. The grinding mill comprises a grinding cylinder and a motor assembly adapted to rotate the grinding cylinder. When the material is dispensed into the grinding mill from the dispenser, and the motor assembly is engaged, thereby causing the grinding cylinder to rotate, the material is moved along a tapered passage and forced across a sharp edge, causing the material to be ground, crushed, broken, flattened, or cut, dispensing the material into a material receiving portion and thereby allowing the material to be delivered to the user.

### CROSS REFERENCE TO RELATED APPLICATION

This application is a non-provisional application claiming priority to an earlier filed U.S. provisional patent application entitled, “GRAIN MILL,” filed Oct. 17, 2012, and assigned Ser. No. 61/714,808, the contents of which are herein incorporated by reference.

### BACKGROUND OF THE INVENTION

1. Field of the Invention

The present invention generally relates to a milling device, and particularly to a grain mill.

2. Description of the Related Art

Traditionally, oats are prepared in a few different ways. Once the husk is removed, the resulting oat groats are either chopped into smaller pieces to produce steel-cut oats or steamed and rolled to produce rolled oats. Although steel-cut oats are more textured than rolled oats, they take a long time to cook, usually at least fifteen minutes. Rolled oats, on the other hand, are quicker to cook, but tend to produce softer oatmeal and lose the texture and mouth feel of the steel-cut oats.

Previous attempts to produce textured oats with short cooking times have resulted in what are called instant oats. Instant oats are typically produced by taking steel-cut oats and subjecting them to a steaming process in order to prepare the oat for quicker cooking. However, the resulting instant oats still lose texture through the steaming process, and produce softer oatmeal than traditional and steel-cut oats. Furthermore, instant oats are oftentimes produced in a factory setting due to the requirements of the steaming process. As a result, there is a significant period of time between processing and when the consumer receives the processed oats, resulting in oats that are not very fresh.

The invention described herein solves these disadvantages by providing a portable grain mill capable of processing materials in a retail setting. In the particular case of oats, the inventive grain mill provides fresher product to the end consumer, capable of cooking more quickly than steel-cut oats, and having an improved texture over instant oats.

### SUMMARY OF THE INVENTION

In one embodiment of the invention, the grain mill comprises a grinding mill adapted to receive a material. The grinding mill further comprises a grinding cylinder, an inner concave surface, and a motor assembly. The inner concave surface is positioned adjacent the grinding cylinder, thereby creating a tapered passage between the inner concave surface and the grinding cylinder. The tapered passage becomes progressively narrow from an inlet to an outlet. The motor assembly is adapted to rotate the grinding cylinder. When the material is received into the grinding mill at the inlet of the tapered passage, and the motor assembly is engaged, the grinding cylinder will rotate, thereby moving the material along the tapered passage and forcing the material out the outlet, during which the material is ground, crushed, flattened, or broken.

In another form of the invention, a grain mill is presented herein comprising a dispenser adapted to receive and store a material. The dispenser comprises a cavity capable of housing the material, and an outlet opening capable of delivering the material. The grain mill further comprises a grinding mill adapted to receive the material from the outlet opening of the dispenser. The grinding mill comprises a grinding cylinder and a motor assembly adapted to rotate the grinding cylinder. The grain mill further comprises a support assembly adapted to receive the material from the grinding mill into a material receiving portion. When the material is dispensed into the grinding mill from the dispenser, and the motor assembly is engaged, the grinding cylinder will rotate, thereby moving the material along a tapered passage and forcing the material across a sharp edge, causing the material to be ground, crushed, flattened, broken, or cut, dispensing the material into the receiving portion of the support assembly and thereby allowing the material to be delivered to the user.

In still another embodiment of the invention, the grain mill comprises a dispenser, a grinding mill, and a support assembly. The dispenser is adapted to receive and store a material. The dispenser comprises two side walls connected by a top wall, a bottom wall, a front wall, and a back wall, thereby forming a cavity adapted to house the material therein. The dispenser further comprises an outlet opening adapted to accommodate a chute adapted to deliver the material.

The grinding mill is adapted to receive the material from the chute. The grinding mill comprises a textured grinding cylinder, an inner concave surface, and a motor assembly. The inner concave surface has a smooth texture and is positioned adjacent the grinding cylinder, thereby creating a tapered passage between the inner concave surface and the grinding cylinder. The tapered passage becomes progressively narrow from an inlet to an outlet, where the smallest distance between the grinding cylinder and the inner concave surface is between 0.035 and 0.045 inches. The motor assembly is adapted to rotate the grinding cylinder. The motor assembly further comprises a motor attached to a switch mechanism. The switch mechanism is adapted to electrically connect the motor assembly to an electric power source. The switch mechanism is further adapted to provide or terminate power to the motor. When the switch mechanism provides power to the motor, the motor causing the grinding cylinder to rotate. When the switch mechanism terminates power to the motor, the motor stops rotating the grinding cylinder.

The support assembly includes a material receiving portion, a device receiving portion, and a ground interfacing portion. The material receiving provides a location to collect the material as it is dispensed from the grinding mill. The device receiving portion is adapted to provide support for the dispenser and the grinding mill. The ground interfacing portion is adapted to provide stability and support to the grain mill while also allowing for transportability;

The material is received from the dispenser, through the chute, into the grinding mill at the inlet of the tapered passage. When the motor assembly is engaged, the grinding cylinder will rotate, thereby moving the material along the tapered passage and forcing the material across a sharp edge at the termination of the outlet of the tapered passage. This causes the material to be ground, crushed, broken, flattened, or cut and dispenses the material into the material receiving portion of the support assembly, allowing the material to be delivered to the user.

### BRIEF DESCRIPTION OF THE DRAWING FIGURES

Other advantages of the present invention will be readily understood by reference to the following detailed description in connection with the accompanying drawings wherein:

FIG. 1 is a perspective view of the front of a grain mill;

FIG. 2 is a perspective view of the grain mill's dispenser;

FIG. 3 is a perspective view of the top surface of the dispenser;

FIG. 4 is an side view of the grain mill's chute;

FIG. 5 is a perspective view of the grain mill's grinding mill;

FIG. 6 is a perspective view of the grain mill's grinder housing;

FIG. 7 is a perspective view of the grain mill's grinder housing assembled with a stationary block and a grinding cylinder;

FIG. 8 is a perspective view of the grain mill's grinder housing, with various parts removed to demonstrate the shape and configuration of the grinder housing;

FIG. 9 is a perspective view of the grain mill's grinding cylinder;

FIG. 10 is a perspective view of the grain mill's spout and deflector;

FIG. 11 is an side view of the grain mill's motor assembly; and

FIG. 12 is a perspective view of a preferred form of the grain mill's support assembly.

### DESCRIPTION OF THE VARIOUS EMBODIMENTS

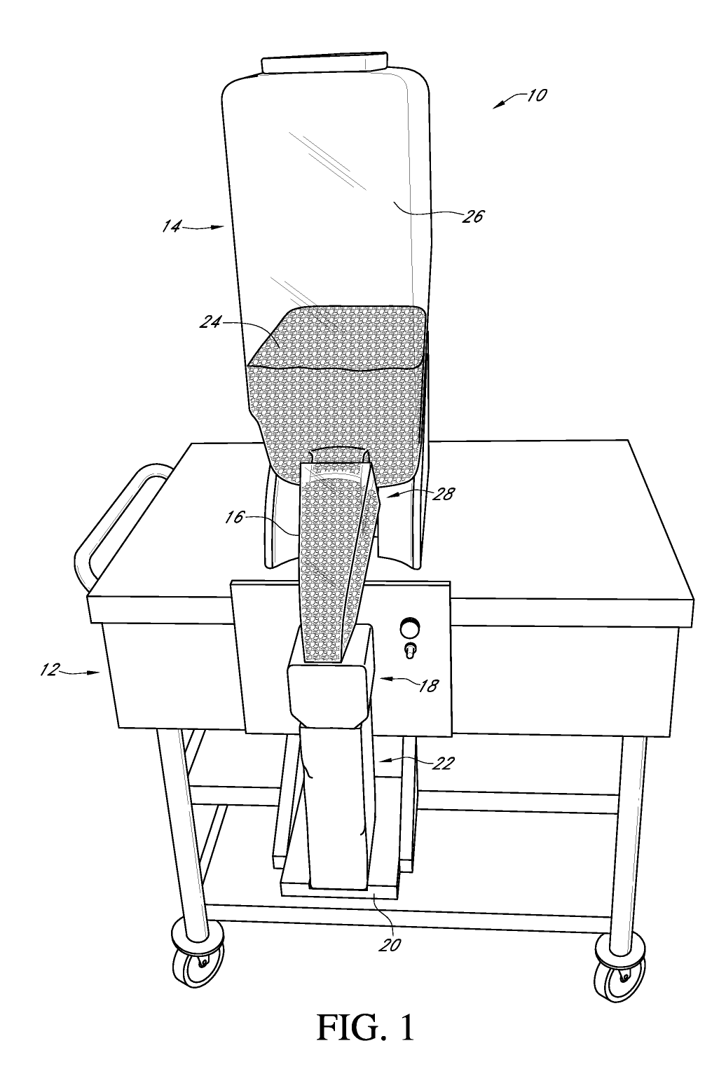

For purposes of the following description, the terms “upper,” “lower,” “left,” “rear,” “front,” “vertical,” “horizontal” and derivatives of such terms shall relate to the invention as oriented in FIG. 1. However, it is to be understood that the invention may assume various alternative orientations and configurations, except where expressly specified to the contrary. It is also to be understood that the devices illustrated in the attached drawings and described in the following specification are simply exemplary embodiments of the inventive concepts described herein. Specific dimensions and other physical characteristics relating to the embodiments disclosed herein are not to be considered as limiting unless expressly stated otherwise.

As used herein, the term “groats” generally refers to a grain that has been ‘hulled’ by removing its outer covering or husk. Hulled grains, such as oats, wheat, or barley, represent the most common form of grains from which “groats” are derived, however the term “groats” as used herein refers to any grain which is broken or crushed, and is not intended to limit the scope of the invention.

An improved grain mill 10 is presented herein comprising: a support assembly 12, a dispenser 14, a chute 16, and a grinding mill 18. The support assembly 12 provides support for the grain mill 10, securing the dispenser 14, the chute 16, and the grinding mill 18 in position relative to one another. The support assembly 12 further allows for the grain mill 10 to be easily transported via casters or the like, and optionally provides a material receiving portion 20 adapted to hold a bag or other receptacle to receive processed material 22.

In one embodiment of the present invention, the support assembly 12 is constructed so that a material 24 feeds from the dispenser 14, to the chute 16, and into the grinding mill 18. The material is then ground or broken, wherein it exits from the grinding mill 18 as processed material 22, into the material receiving portion 20 of the support assembly 12.

The dispenser 14 as set forth above is preferably a container for storing the material 24 and delivering the material 24 into the grinding mill 18. The dispenser may be of any shape which forms a cavity 26 capable of housing the material 24 and delivering the same to the grinding mill 18. Preferred shapes for the dispenser 14 include circular, rectangular, or polygonal forms, and may include an integrated chute portion 28.

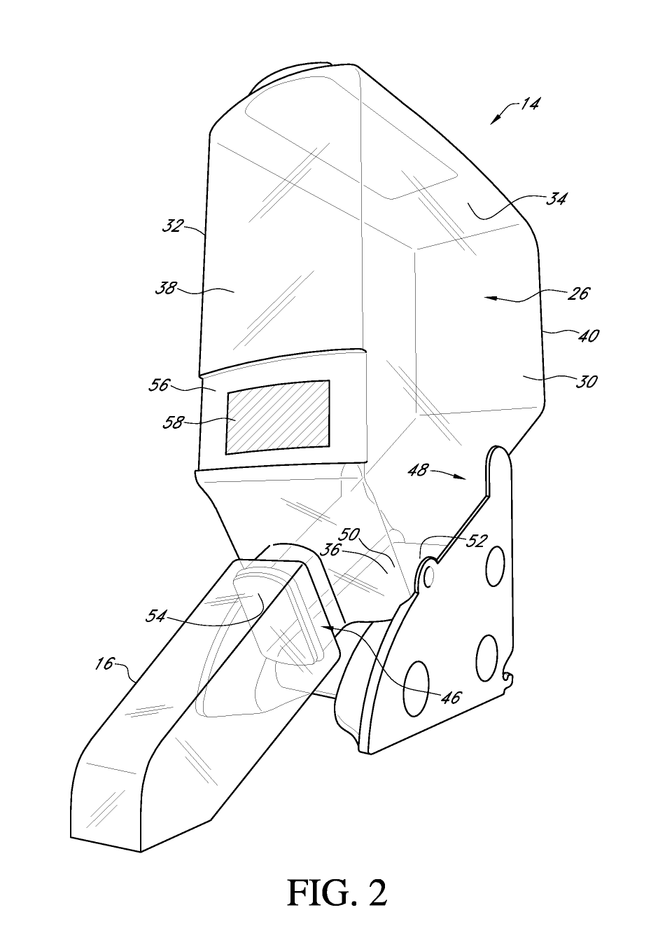

In the form of the present invention shown in FIG. 2, the dispenser is generally rectangular in form and includes two side walls (30, 32) connected by a top wall 34, a bottom wall 36, a front wall 38, and a back wall 40, thereby forming a cavity 26 adapted to house the material 24 therein. The side walls (30, 32), the top wall 34, the bottom wall 36, the front wall 38, and the back wall 40 may be integrally formed, preferably by a vacuum molding process, and may be constructed from any materials suitable in the art.

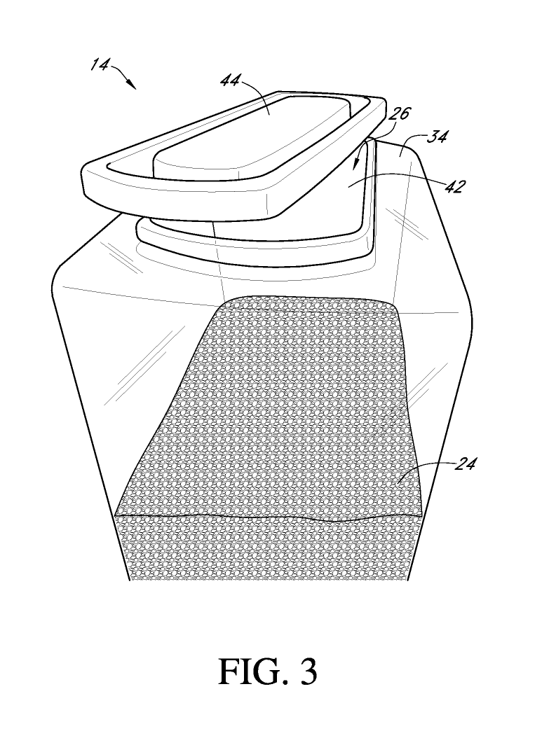

A preferred form of the top wall 34 of the dispenser 14, is shown in FIG. 3 and further comprises an inlet opening 42 adapted to receive the material 24 into the cavity 26 of the dispenser 14. The top wall 34 further comprises a removable lid 44 adapted to cover the inlet opening 42, thereby sealing the dispenser 14 and preventing foreign debris from entering the dispenser 14.

In reference to FIG. 2, a preferred form of the bottom wall 36 of the dispenser 14 is shown, which comprises a front end 46 disposed adjacent the front wall 38 of the dispenser 14 and a back end 48 disposed adjacent the back wall 40 of the dispenser 14. The bottom wall 36 further comprises a ramp 50 downwardly inclined from the back end 48 towards the front end 46, the ramp 50 comprising a surface 52 adapted to permit the material 24 to downwardly flow toward the front end 46.

Continuing with FIG. 2, a preferred form of the front wall 38 of the dispenser 14 further includes an outlet opening 54 at the intersection between the front wall 38 and the front end 46 of the bottom wall 36 as shown in FIG. 2. The outlet opening 54 is adapted to accommodate the chute 16, wherein the material 24 flows from the ramp 50 to the front end 46 and enters the chute 16 through the outlet opening 54. Optionally, the front wall 38 may further include a compartment 56 adapted to hold a label 58 for purposes of identifying and describing the material 24 stored therein.

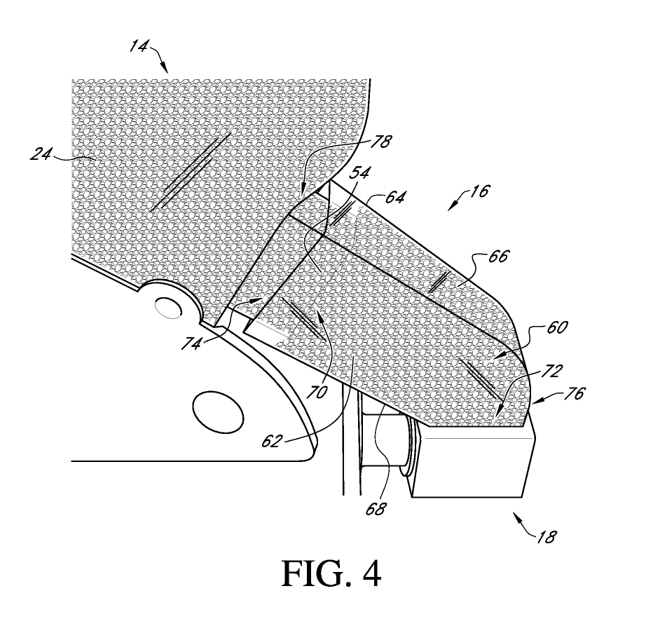

The chute 16, as set forth above and shown in FIG. 4, delivers the material 24 from the dispenser 14 into the grinding mill 18. The chute 16 may be of any shape which forms a pathway 60 capable of delivering the material 24 to the grinding mill 18. Preferred shapes for the chute 16 include circular, rectangular, or polygonal forms, and may be constructed from any materials suitable in the art.

In the embodiment of the invention shown in FIG. 4, the chute 16 includes a rectangular shape comprised of two side walls (62, 64) connected by a top wall 66, a bottom wall 68, an inlet end 70, and an outlet end 72. The inlet end 70 of the chute 16 further comprises a flanged portion 74 adapted to removeably attach to the outlet opening 54 of the dispenser 14. When the inlet end 70 of the chute 16 is attached to the dispenser 14 at the outlet opening 54, the bottom wall 68 of the chute 16 forms a downward incline, thereby enabling the material 24 to flow from the inlet end 70 to the outlet end 72. In this embodiment, the outlet end 72 of the chute 16, is adapted to attach to the grinding mill 18. It is preferred that the chute 16's side walls (62, 64), top wall 66, and bottom wall 68 are integrally formed from a single piece of molded plastic, however the chute 16 may be comprised of any number of walls, or may be constructed of any material known in the art.

In a further embodiment of the invention, the chute 16 further comprises a gate 76 at the outlet end 72 of the chute 16; the gate 76 adapted to control the flow of the material 24 to the grinding mill 18. The gate 76 is pivotable between open and closed positions, wherein when the gate 76 is in the open position, the material 24 can freely flow to the grinding mill 18, and when the gate 76 is in the closed position, the material 24 is restricted from progressing into the grinding mill 18. Optionally, the pivoting action of the gate 76 may be actuated by a user via a switch or other mechanical device, or the gate 76 may be pivoted by an automatic means such as by a device that opens the gate 76 at timed intervals or after the grinding mill 18 has finished grinding other material 24. In no way is this meant to be limiting, and the gate 76 may comprise any barrier which arrests material 24 flow. In an alternate form of the present invention, the gate 76 may be added to the inlet end 70 of the chute 16 instead of the outlet end 72 or at any position therebetween.

In another embodiment of the invention, the chute 16 may further comprise a selector 78 at the inlet end 70, the selector 78 adapted to allow the user to select between multiple dispensers 14. In one embodiment, the selector 78 may allow for the chute 16 to be slideably or rotatably adjusted so as to allow the inlet end 70 of the chute 16 to align with the outlet opening 54 of one of any number of dispensers 14, or between internal partitions within the dispenser 14. It is anticipated that the material 24 may differ between dispensers 14, thereby providing the user a choice of material 24. It is also anticipated that the same material 24 may be used in multiple dispensers 14 in the event that one of the dispensers is emptied. Further, the selector 78 may include a mid-point setting for mixing materials 24, allowing the grinding mill 18 to receive material 24 from more than one dispenser 14 simultaneously. The form of the selector 78 described herein is not intended to be limiting in any way, and the selector 78 may comprise any such device capable of selection between varying materials 24.

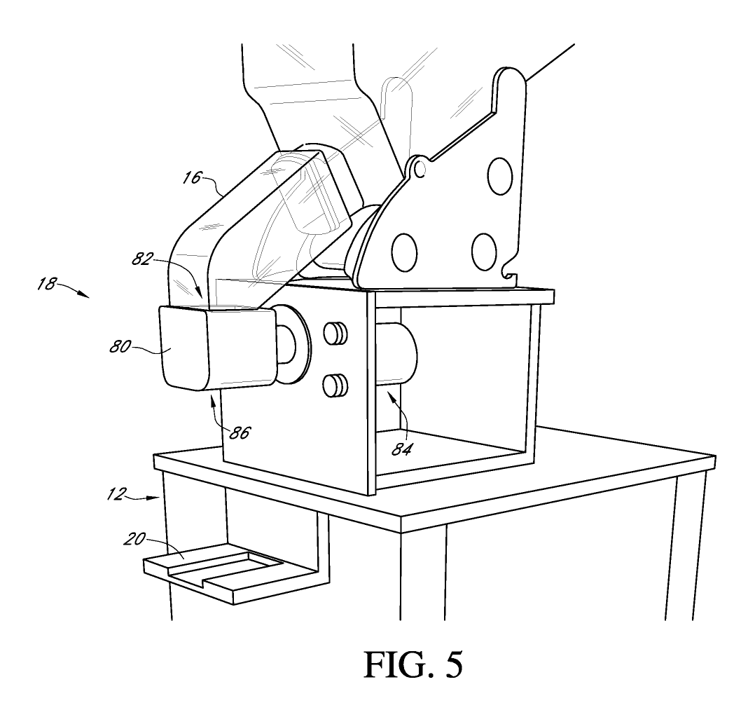

The grinding mill 18 set forth above and shown in FIG. 5, comprises a grinder housing 80, a grinding cylinder 82, and a motor assembly 84. Wherein, the grinder housing 80 may be of any shape which allows the material 24 to be ground, broken into smaller pieces, or crushed by the grinding cylinder 82, creating processed material 22. Preferred shapes for the grinder housing 80 include polygonal, circular, or rectangular forms, which are adapted to receive material 24 from the chute 16, grind, crush, break, or cut it, and deliver the processed material 22 via an outlet 86 to the material receiving portion 20 of the support assembly 12. As the material 24 enters the grinder housing 80, it is ground, broken, crushed, flattened, or cut into smaller pieces by the grinding cylinder 82, which is rotated by the motor assembly 84, wherein processed material 22 exits the grinding mill 18 and is received for use.

In one embodiment of the invention, the grinder housing 80 is comprised of extruded aluminum that has been anodized to increase resistance to corrosion and wear. In another embodiment, the grinder housing 80 is comprised of an aluminum block that has been milled to shape by a Computer Numerical Control (CNC) mill. In yet another embodiment, the grinder housing 80 is comprised of extruded aluminum material that has been subsequently milled by a CNC mill. Of course, this is not meant to be limiting in any way and the grinder housing 80 and its components may be constructed from any materials and using any processes which are acceptable in the art.

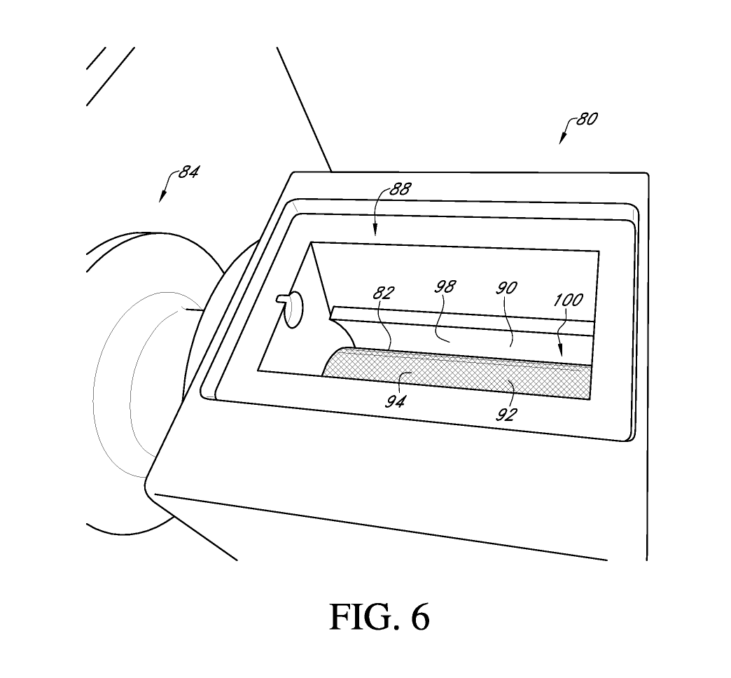

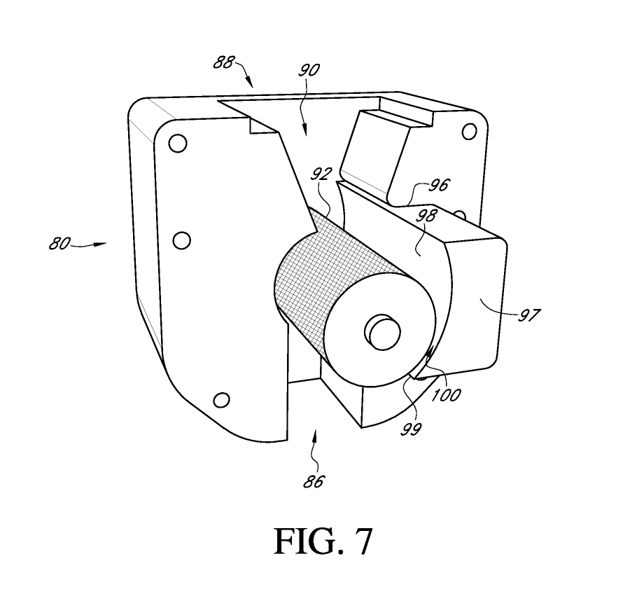

One embodiment of the grinder housing 80, as shown in FIG. 6 and FIG. 7, includes an inlet 88, a concave portion 90, a grinding cylinder 82, and the outlet 86. Referring to FIG. 6, The grinding cylinder 82 is positioned within the grinder housing 80 such that an outer surface 92 of the grinding cylinder 82 is positioned adjacent an inner surface 98 of the concave portion 90 of the grinder housing 80, thereby creating a tapered passage 100 between the outer surface 92 and the inner surface 98 for the material 24 to pass through. The outer surface 92 and inner surface 98 are adapted to grind, crush, break, or cut the material 24 as it passes through the tapered passage 100 by reducing the distance between the outer surface 92 and the inner surface 98, forcing material 24 between the grinding cylinder 82 and the grinder housing 80.

The outer surface 92 of the grinding cylinder 82, may further comprise a texture 94 such as a knurl, diamond pattern, horizontal pattern, vertical pattern, v-shaped pattern, or the like to assist with the grinding, crushing, or breaking of the material 24. The inner surface 98 may also be similarly textured to assist with the grinding, crushing, or breaking of the material 24. In one preferred embodiment, shown in FIG. 7, the inner surface 98 is smooth in texture, coming to a sharp edge 99 at the end of tapered passage 100, thereby enabling the material 24 to be broken via a cutting action.

The grinding cylinder 82 is preferably spaced to accept dry materials and preferably oat groats. In one preferred embodiment of the invention, shown in FIG. 6 and FIG. 7, the outer surface 92 of the grinding cylinder 82 is positioned between 0.035 and 0.045 inches, preferably 0.040 inches, from the inner surface 98 of the grinder housing 80 when measured from the end of the tapered passage 100 adjacent to the sharp edge 99. However, the grinding cylinder 82 may be spaced in any such position so as to accommodate the type of material 24 being ground, thereby adjusting the resulting size of the processed material 22. In one embodiment of the invention, the grinding cylinder 82 may be adjustably positioned relative to the inner surface 98 so that the size of the processed material 22 may be selectively controlled.

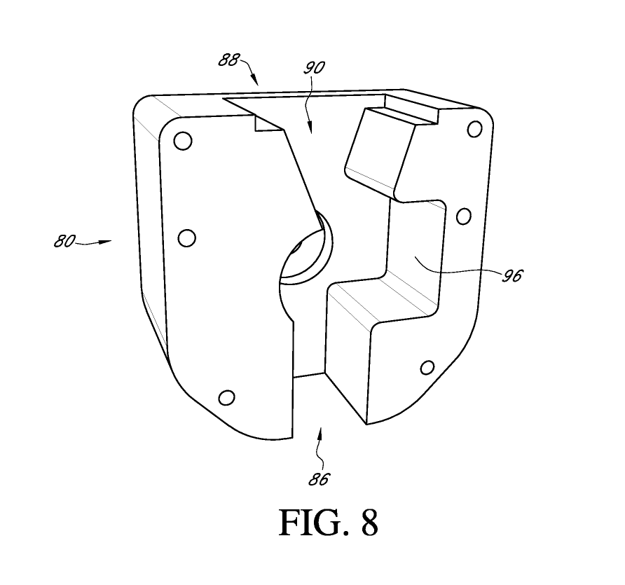

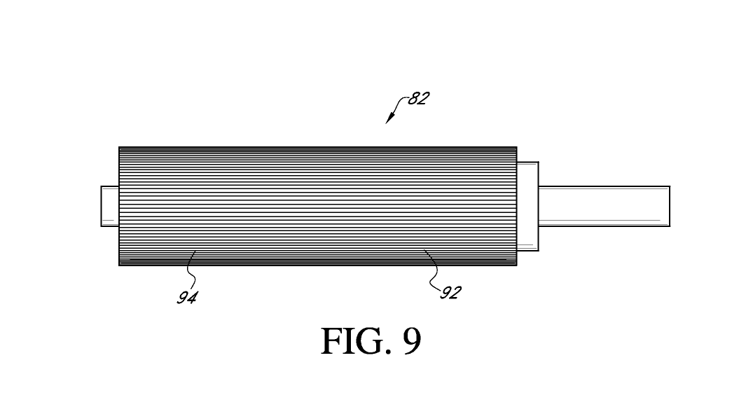

In one embodiment of the grinder housing 80, shown in FIG. 7, the concave portion 90 further comprises a receiving area 96 adapted to receive a stationary block 97 that includes the inner surface 98. In this embodiment, the stationary block 97 is removable from the receiving area 96, thereby allowing for maintenance or replacement of the inner surface 98. The removability of the stationary block 97 also allows for the replacement of the stationary block 97 with alternative stationary blocks 97 of varying sizes and inner surface 98 compositions, thereby allowing for the size of the tapered passage 100 and the resulting processed material 22 to be selectively controlled. In a similar way, the grinding cylinder 82 may also be removed for maintenance or replacement, as demonstrated in FIG. 8, which shows an embodiment of the grinder housing 80 wherein both the stationary block 97 and the grinding cylinder 82 have been removed. FIG. 9 shows the grinding cylinder 82, its outer surface 92, and its texture 94 after the grinding cylinder 82 has been removed from the grinder housing 80.

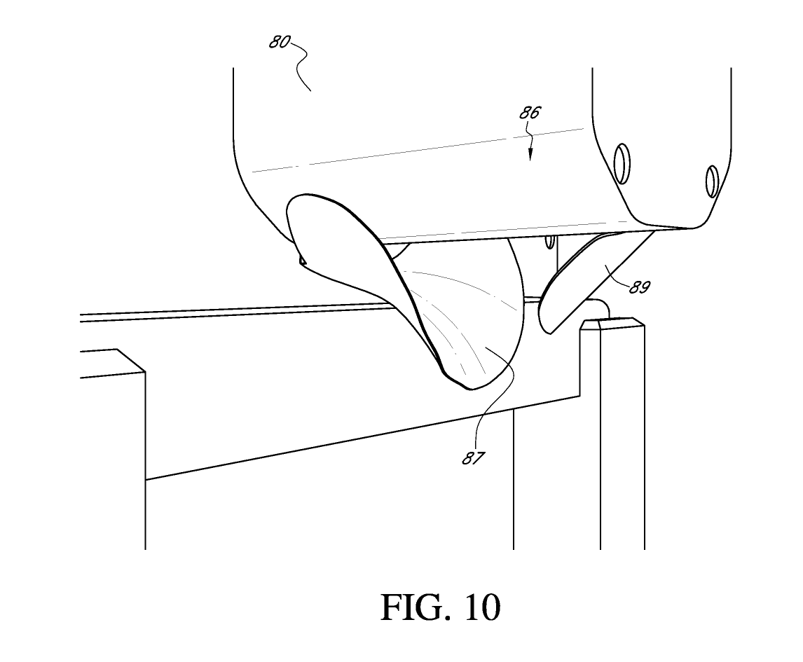

The outlet 86 is adapted to deliver the material 22 from the grinding mill 18 to the material receiving portion 20 of the of the support assembly 12. In one embodiment, shown in FIG. 7 and FIG. 8, the outlet 86 comprises a substantially rectangular shape, wherein in another embodiment, the outlet may comprise a tapered or graduated shape to further direct the material 24 to the material receiving portion 20 of the support assembly 12. In another preferred embodiment, shown in FIG. 10, the outlet 86 includes a spout 87 adapted to properly direct the material 22 as it leaves the grinding mill 18. In this embodiment, the outlet 86 also includes a deflector 89 adapted to redirect stray material 22 back onto the spout 87, thereby maximizing the amount of material 22 delivered to the material receiving portion 20 and minimizing spillage.

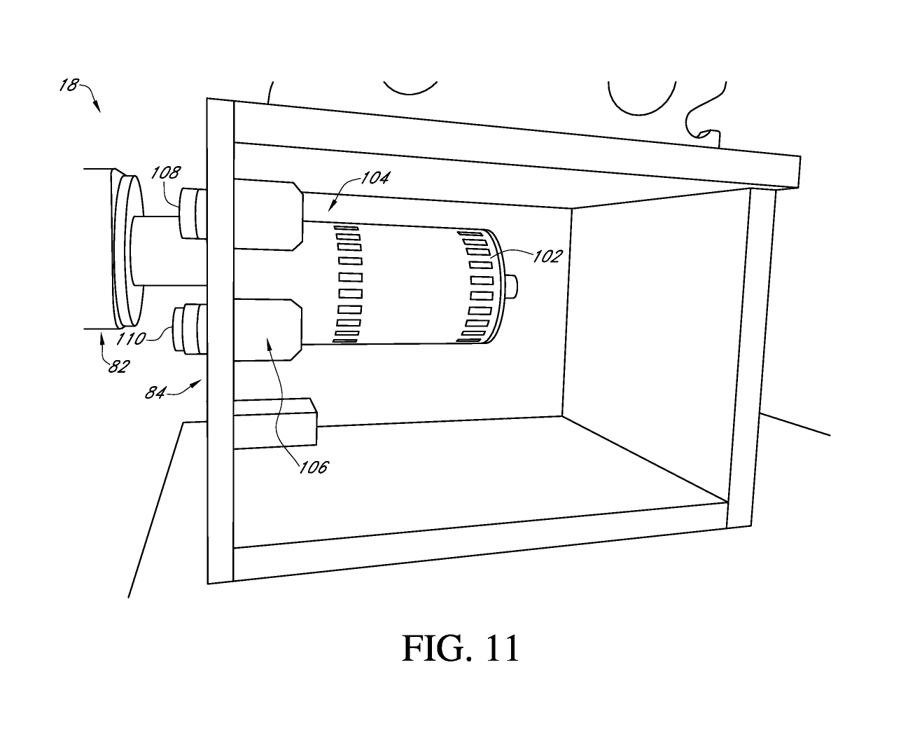

The motor assembly 84 set forth above is a device for powering the grinding cylinder 82. As such, the motor assembly 84 may be of any shape or configuration which allows for the powering of the grinding cylinder 82 and controlling the operation thereof. A preferred form of the motor assembly 84 is shown in FIG. 11 and further comprises an electrically powered motor 102 coupled to a reduction gearset 104. The motor 102 is attached to a switch mechanism 106 adapted to electrically connect the motor 102 to an electric power source. The reduction gearset 104 is adapted to attach to the grinding cylinder 82 of the grinding mill 18 and thereby rotate the grinding cylinder 82 when the motor 102 is powered.

The reduction gearset 104 may attach to the grinding cylinder 18 in any way known in the art. In one preferred embodiment of the invention, the grinding cylinder 18 comprises a female configuration and the reduction gearset 104 comprises a male configuration so as to create an optimally rigid connection capable of rotating the grinding cylinder 82 at the preferred speed. In one preferred embodiment of the invention, the reduction gearset 14 is adapted to rotate the grinding cylinder 82 at an optimal speed of between fifty and seventy revolutions per minute, preferably sixty revolutions per minute, resulting in the material 24 being ground into an ideal size and texture. However, this is not meant to be limiting, and the grinding cylinder 82 may be configured to rotate at any such speed as will create suitable processed material 22 and may, in fact, be configured to rotate at adjustable speeds to accommodate different types of material 24 or to create processed material 22 of varying size and shape.

The switch mechanism 106 preferably comprises a start button 108 and a stop button 110, whereby the start button 108, provides electric power to the motor 102, thereby rotating the grinding cylinder 82. The stop button 110 terminates power to the motor 102, thereby causing the grinding cylinder 82 to stop. However, it is anticipated that the switch mechanism 106 may comprise any power control mechanism known in the art, including single pole switches, relays, and the like.

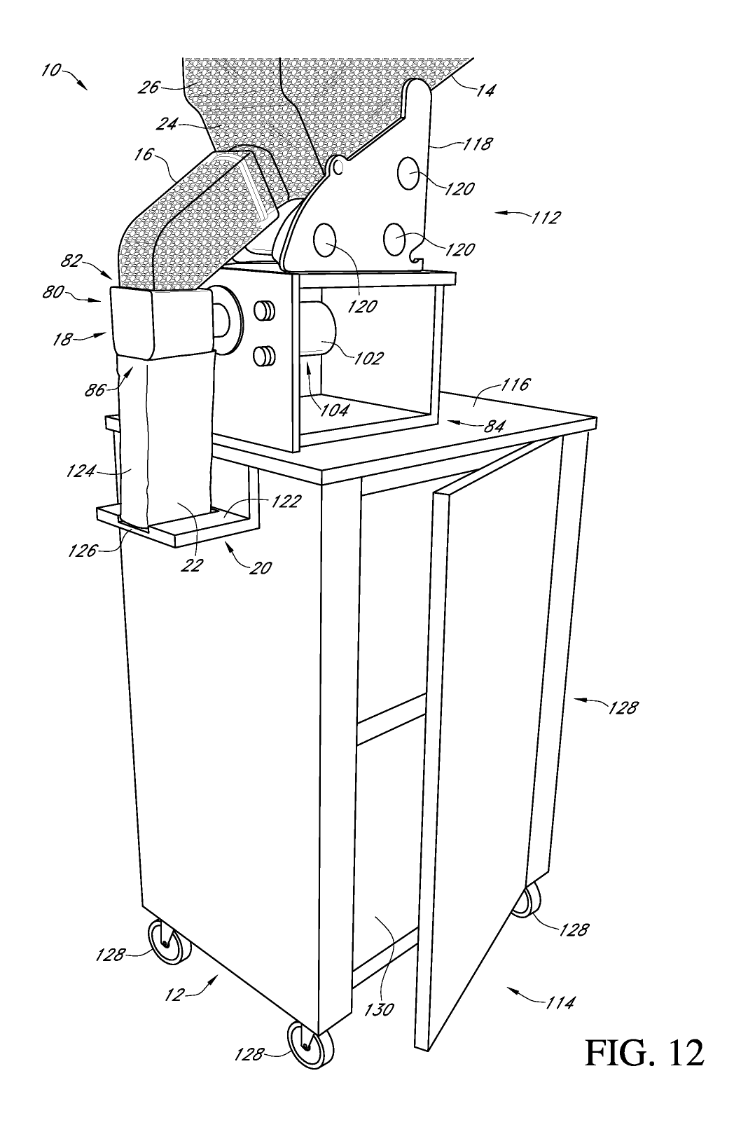

The support assembly 12 set forth above and shown in FIG. 12 is adapted to support the grain mill 10 and position it in such a way so as to facilitate the storage of the material 24 in the dispenser 14, the delivery of the material 24 to the grinding mill 18, and the receipt of the material 22 by the user. Additionally, the support assembly 12 includes ground interfacing elements 128, such as casters or the like, that enable the grain mill 10 to be easily moveable between various locations, including retail locations such as grocery stores and farmers markets.

In one embodiment of the present invention, a preferred form of the support assembly 12 is shown in FIG. 12, and includes a device receiving portion 112, a material receiving portion 20, and a ground interfacing portion 114. The device receiving portion 112 is adapted to provide support for the dispenser 14, the chute 16, and the grinding mill 18. The material receiving portion 20 provides a location to collect the material as it is dispensed from the grinding mill 18. The ground interfacing portion 114 is adapted to provide stability and support to the grain mill 10 while also allowing for portability and transportability.

A preferred form of the device receiving portion 112 is adapted to receive and support the dispenser 14, the chute 16, and the grinding mill 18 in position to enable operation. It is anticipated that the device receiving portion 112 can support the dispenser 14, the chute 16, and the grinding mill 18 in a number of configurations. In one configuration, the grinding mill 18 may be attached to a top surface 116 of the device receiving portion 112, with the dispenser 14 and chute 16 attached to the grinding mill 18. In another configuration, the dispenser 14 and chute 16 may be attached to the top surface 116 of the device receiving portion 112, with the grinding mill 18 contained within the device receiving portion 112. In yet another configuration, the device receiving portion 112 may further comprise a dispenser stand 118 adapted to hold the dispenser 14 in an upright position. It is anticipated that the device receiving portion 112 may use any number of fastening devices 120 to secure the dispenser 14, the chute 16, and the grinding mill 18 in place, including, but not limited to, screws, bolts, pins, rivets, snap locks, and the like.

A preferred form of the material receiving portion 20 of the of the support assembly 12 comprises a horizontally disposed surface 122 located below the grinding mill 18 and adapted to receive a storage container 124 such as a bag or other container suitable of holding the processed material 22. Optionally, the horizontally disposed surface 122 may further include an indented portion 126 adapted to further enable the surface 122 to accommodate the particular shape or size of the storage container 124.

A preferred form of the ground interfacing portion 114 comprises four ground interfacing elements 128. Preferably, the ground interfacing elements 128 may comprise freely adjustable wheels or casters with a mechanism to lock the wheels in place, thereby enabling the grain mill 10 to be fixed in place during operation while also allowing the grain mill 10 to be easily moved for ideal placement or storage. It is anticipated that the ground interfacing elements 128 may further comprise any number or configuration which permits the support assembly 12 to support the grain mill 10 while in use.

Optionally, the support assembly 12 may further include a storage area 130 adapted to store miscellaneous items, such as extra material 24 or storage containers 124. The storage area 130 may be integrated into the support assembly 12, may be placed on top of the support assembly 12, or may be located in any position on the support assembly 12 that allows for such items to be stored in the grain mill 10.

The invention as described above may be used by feeding material 24 into the grinding mill 18 via the inlet opening 42 of the dispenser 14. The material 24 remains stored in the cavity 26 of the dispenser 14 until dispensed, preferably via gravity feed as the material 24 in the grinding mill 18 is ground and dispensed. The lid 44 of the dispenser 14 may be removed in order to refill the cavity 26 with additional material 24.

When the material 24 is dispensed from the dispenser 14, the material 24 is preferably delivered by gravity feed via the chute 16 to the grinding mill 18. The material 24 enters the grinder housing 80 at the inlet 88. When in operation, the motor 102 of the motor assembly 84 rotates the reduction gearset 104, thereby rotating the grinding cylinder 82 and causing the material 24 to enter the tapered passage 100, where the outer surface 92 of the grinding cylinder 82 and the inner surface 98 of the concave portion 90 grind, crush, break, or cut the material 24. The processed material 22 is then dispensed from the grinding mill 18 at the outlet 86 and optionally delivered, via gravity or other means, to the storage container 124 located at the material receiving portion 20 of the support assembly 12.

The above description is considered that of the preferred embodiments and their uses only. Modifications to the invention will occur to those skilled in the art and those who make use of the invention. Therefore, it is understood that the embodiments shown in the drawings and the examples set forth herein are described merely for illustrative purposes, and are not intended to limit the scope of the invention as interpreted according to the principles of patent law, including the doctrine of equivalents.

1. A grain mill comprising:
a grinding mill adapted to receive a material, the grinding mill further comprising:
a grinding cylinder;
an inner concave surface positioned adjacent the grinding cylinder, thereby creating a tapered passage between the inner concave surface and the grinding cylinder, the tapered passage becoming progressively narrow from an inlet to an outlet; and
a motor assembly adapted to rotate the grinding cylinder;
wherein, when the material is received into the grinding mill at the inlet of the tapered passage, and the motor assembly is engaged, the grinding cylinder will rotate, thereby moving the material along the tapered passage and forcing the material out the outlet, during which the material is ground, crushed, flattened, or broken.

2. The grain mill of claim 1, further including a sharp edge at the termination of the outlet of the tapered passage, thereby causing the material moving along the tapered passage to be further ground, crushed, flattened, broken, or cut as the material exits the outlet.

3. The grain mill of claim 2, further comprising a texture located on the grinding cylinder.

4. The grain mill of claim 2, further comprising a smooth texture located on a portion of the inner concave surface.

5. The grain mill of claim 4, further comprising a texture located on the grinding cylinder.

6. The grain mill of claim 1, wherein the grinding mill further comprises a receiving area adapted to receive a stationary block that includes the inner concave surface; wherein the stationary block is removable from the receiving area and the grinding mill.

7. The grain mill of claim 1, wherein the grinding cylinder is positioned such that the smallest distance between the grinding cylinder and the inner concave surface is between 0.035 and 0.045 inches.

8. The grain mill of claim 1, wherein the motor assembly further comprises a motor attached to a switch mechanism, the switch mechanism adapted to electrically connect the motor to an electric power source, the switch mechanism further adapted to provide or terminate power to the motor; wherein, when the switch mechanism provides power to the motor, the motor causes the grinding cylinder to rotate, and when the switch mechanism terminates power to the motor, the motor stops rotating the grinding cylinder.

9. The grain mill of claim 1, wherein the grinding mill further comprises a spout adjacent the outlet, the spout adapted to direct the material as it leaves the grinding mill.

10. The grain mill of claim 10, wherein the grinding mill further comprises a deflector adapted to direct material onto the spout, thereby maximizing the amount of material delivered to the user and minimizing spillage.

11. A grain mill comprising:
a dispenser adapted to receive and store a material, the dispenser comprising a cavity capable of housing the material and an outlet opening capable of delivering the material;
a grinding mill adapted to receive the material from the outlet opening of the dispenser, the grinding mill comprising a grinding cylinder and a motor assembly adapted to rotate the grinding cylinder; and
a support assembly adapted to receive the material from the grinding mill into a material receiving portion;
wherein, when the material is dispensed into the grinding mill from the dispenser, and the motor assembly is engaged, the grinding cylinder will rotate, thereby moving the material along a tapered passage and forcing the material across a sharp edge, causing the material to be ground, crushed, broken, flattened, or cut, dispensing the material into the material receiving portion of the support assembly and thereby allowing the material to be delivered to the user.

12. The grain mill of claim 11, wherein the dispenser includes two side walls connected by a top wall, a bottom wall, a front wall, and a back wall, thereby forming the cavity adapted to house the material therein.

13. The grain mill of claim 12, the top wall of the dispenser further comprising an inlet opening and a removable lid, the inlet opening adapted to receive the material into the cavity of the dispenser, and the removable lid adapted to cover the inlet opening, thereby sealing the dispenser and preventing foreign debris from entering the dispenser.

14. The grain mill of claim 11, wherein the outlet opening is adapted to accommodate a chute adapted to deliver the material from the dispenser to the grinding mill.

15. The grain mill of claim 14, wherein the chute comprises a rectangular shape comprised of two side walls connected by a top wall, a bottom wall, an inlet end, and an outlet end, the inlet end further comprising a flanged portion adapted to removeably attach to the dispenser at the outlet opening; wherein when the inlet end of the chute is attached to the dispenser at the outlet opening, the bottom wall of the chute forms a downward incline, thereby enabling the material to flow from the inlet end to the outlet end and thereon to the grinding mill.

16. The grain mill of claim 11, wherein the support assembly is further adapted to secure the dispenser and the grinding mill in position relative to one another.

17. The grain mill of claim 11, wherein the support assembly includes a device receiving portion adapted to provide support for the dispenser and the grinding mill, a material receiving portion providing a location to collect the material as it is dispensed from the grinding mill, and a ground interfacing portion adapted to provide stability and support to the grain mill while also allowing for transportability.

18. The grain mill of claim 17, wherein the material receiving portion of the support assembly comprises a horizontally disposed surface located below the grinding mill and adapted to receive a storage container suitable for receiving the processed material as it exits the grinding mill.

19. The grain mill of claim 17, wherein the ground interfacing portion comprises four ground interfacing casters.

20. A grain mill comprising:
a dispenser adapted to receive and store a material, the dispenser comprising two side walls connected by a top wall, a bottom wall, a front wall, and a back wall, thereby forming a cavity adapted to house the material therein, the dispenser further comprising an outlet opening adapted to accommodate a chute adapted to deliver the material;
a grinding mill adapted to receive the material from the chute, the grinding mill comprising:
a grinding cylinder having a texture;
an inner concave surface having a smooth texture and positioned adjacent the grinding cylinder, thereby creating a tapered passage between the inner concave surface and the grinding cylinder, the tapered passage becoming progressively narrow from an inlet to an outlet; wherein the smallest distance between the grinding cylinder and the inner concave surface is between 0.035 and 0.045 inches;
a motor assembly adapted to rotate the grinding cylinder, the motor assembly further comprising a motor attached to a switch mechanism, the switch mechanism adapted to electrically connect the motor to an electric power source, the switch mechanism further adapted to provide or terminate power to the motor; wherein, when the switch mechanism provides power to the motor, the motor causes the grinding cylinder to rotate, and when the switch mechanism terminates power to the motor, the motor stops rotating the grinding cylinder; and
a support assembly including a material receiving providing a location to collect the material as it is dispensed from the grinding mill, a device receiving portion adapted to provide support for the dispenser and the grinding mill, and a ground interfacing portion adapted to provide stability and support to the grain mill while also allowing for transportability;
wherein, when the material is received from the dispenser, through the chute, into the grinding mill at the inlet of the tapered passage, and the motor assembly is engaged, the grinding cylinder will rotate, thereby moving the material along the tapered passage and forcing it across a sharp edge at the termination of the outlet of the tapered passage, causing the material to be ground, crushed, broken, flattened, or cut, dispensing the material into the material receiving portion of the support assembly and thereby allowing the material to be delivered to the user.
